(19) United States
(12) Patent Application Publication
(10) Pub. No.: US 2006/0222982 A1
(43) Pub. Date: Oct. 5, 2006

(54) Developer and image forming method

(76) Inventor: Sakiko Fujikawa, Osaka (JP)

Correspondence Address: Arthur G. Schaier;Carmody & Torrance LLP, 50 Leavenworth Street, P.O. Box 1110, Waterbury, CT, 06721-1110, US

(21) Appl. No.: 11/388,148

(22) Filed: Mar. 22, 2006

(30) Foreign Application Priority Data
Mar. 31, 2005 (JP) 2005-102990
Sep. 30, 2005 (JP) 2005-285860

(51) Int. Cl. G03G 15/08

(52) U.S. Cl. 430/106.1; 399/279; 430/111.1; 430/110.3; 430/122

(57) ABSTRACT

The present invention provides a developer suitable for a hybrid developing device which may provide a high-quality clear image by suppressing the occurrence of a ghost phenomenon, the occurrence of a carrier-jumping phenomenon and the occurrence of a current leaking phenomenon, and an image forming method which uses such a developer. In a developer which is used for a hybrid developing device which includes a developer transporting body for charging the developer containing carrier and toner while holding magnetism and a developer carrying body for transferring the toner thereto from the transporting body and for forming a thin toner film on a surface thereof, and which is for applying a developing bias to the developer carrying body so as to form a latent image of a latent image carrying body, a specific resistance of the carrier is set to a value which falls within a range of 1×10⁹ to 1×10¹² Ω·cm, the saturation magnetization of the carrier is set to a value which falls within a range of 36 to 60 emu/g, and a specific resistance of the toner is set to a value which falls within a range of 1×10¹³ to 1×10¹⁶ Ω·cm.

### TECHNICAL FIELD

The present invention relates to a developer suitable for an image forming apparatus having a hybrid developing device such as a copying machine, a printer, a facsimile or the like, and an image forming method using the same developer.

In general, an electrophotographic system which includes an image forming apparatus is roughly classified into a 1-component developing system which uses a developer containing a toner as a main component and a 2-component developing system which uses a developer containing a toner and a carrier as main components.

Out of these developing methods, the 1-component developing system includes the developer having the simple constitution and hence, the 1-component developing system has advantages that the developing system exhibits the excellent dot reproducibility and makes the developing devices compact. However, in forming a thin toner layer on a developing sleeve, a blade is used for adjusting a thickness of the toner layer and hence, there has been a drawback that the developing sleeve and the blade are liable to be easily deteriorated thus exhibiting the poor durability.

On the other hand, in the 2-component developing system, the toner is charged by way of the carrier and hence, the 2-component developing system has advantages that such developing system exhibits the excellent electrification property, exhibits the relatively favorable matted image uniformity, and also exhibits the excellent durability. However, the 2-component developing system has drawbacks that the developing devices become complicated and a phenomenon that the carrier is adhered to a surface of a photoreceptor (photoconductor), that is, a so-called jumping of carrier is liable to easily occur.

Further, the toner which is transferred to the surface of the photoreceptor layer is again brought into contact with the carrier and hence, the toner falls and is separated from the surface of the photoreceptor layer thus lowering the image property.

Accordingly, to overcome such drawbacks, there has been proposed a hybrid developing system which is the combination of the 1-component developing system and the 2-component developing system.

The hybrid developing system is a developing system which applies a magnetic 2-component developer which contains a magnetic carrier and a non-magnetic toner to a developing device which includes a magnetic pole member therein and is constituted of a developer transporting body (a magnetic roller) which forms a magnetic brush on a surface thereof, and a developer carrier (developing roller) which is arranged close to the developer transporting body and forms a thin toner layer on a surface thereof.

Such a hybrid developing system can ensure the durability of the developing sleeve and the thickness restricting blade which is the advantage of the 2-component developing system while maintaining the excellent dot reproducibility which is the advantage of the 1-component developing system and hence, it may be possible to provide a developing device which posses the advantages of the 1-component developing system and the 2-component developing system together.

Accordingly, as a developer which is suitable for the hybrid developing system, there have been disclosed a developer which sets a specific resistance of the carrier to a value which falls within a range of 1×10⁸ to 1×10¹² Ω·cm and sets the saturation magnetization of the carrier to a value which falls within a range of 60 to 100 emu/g and an image forming apparatus which uses the developer (for example, see patent document 1).

Further, in the same manner, as a developer which is suitable for the hybrid developing system, there have been disclosed a developer which sets a specific resistance of the carrier to a value which falls within a range of 1×10¹² to 1×10¹⁵ Ω·cm and sets the saturation magnetization of the carrier to a value which falls within a range of 20 to 35 emu/g and an image forming apparatus which uses the developer (for example, see patent document 2).

On the other hand, to prevent the above-mentioned jumping of carrier failure, there have been disclosed a developer which sets an average particle size of the carrier to a value which falls within a range of 52 to 148 μm, sets a specific resistance of the carrier to a value which falls within a range of 7.5×10⁷ to 8.4×10¹³ Ω·cm and sets the saturation magnetization of the carrier to a value which falls within a range of 54 to 75 emu/g and an image forming apparatus which uses the developer (for example, see patent document 3).

[Patent document 1] JP2002-108104A (claims)

[Patent document 2] JP11-184223A (claims)

[Patent document 3] JP5-66614A (claims, Examples)

### DISCLOSURE OF THE INVENTION

### Problems to be Solved by the Invention

However, as described in patent document 1, when the value of the saturation magnetization of the carrier is increased without taking the specific resistance of the toner into consideration, the intensity of the magnetic brush becomes excessively high and hence, a brush mark pattern is formed on the image depending on a use environment and there has been a case that the image property is lowered.

Further, on the other hand, when the value of the saturation magnetization of the carrier is lowered in the same manner as the patent document 2, the intensity of the magnetic brush becomes excessively low and hence, it is difficult to form a uniform thin layer on a developing sleeve and there has been a case that a so-called ghost phenomenon occurs. Further, the specific resistance of the carrier is set to the relatively high value and hence, an electrostatic adhesive force between the toner and the carrier is liable to become strong. Accordingly, when a printing speed becomes a high speed, for example, it is difficult to form a uniform thin layer on a developing sleeve and hence, there has been a case that a ghost phenomenon occurs.

Further, as described in patent document 3, when the carrier having the relatively large average particle is used, although it is possible to prevent the generation of jumping of carrier, depending on the value of the specific resistance of the toner, the electrostatic adhesive force between the toner and the carrier becomes excessively large and hence, there has been also a case that a ghost phenomenon occurs.

Accordingly, the present invention has been made to overcome the above-mentioned drawbacks and inventors of the present invention have found that by restricting a specific resistance of a carrier, a saturation magnetization of the carrier and a specific resistance of a toner respectively to values which fall within predetermined ranges, even when a developer is used in a hybrid developing device, an electrostatic adhesive force between the toner and the carrier is controlled to a value which falls within a proper range and, at the same time, an intensity of a magnetic brush is controlled to a value which falls within a proper range, whereby the generation of jumping of carrier, the generation of a ghost phenomenon and the generation of leaking of an electric current and the like may be suppressed and a high-quality clear image may be obtained and have completed the present invention.

That is, it is an object of the present invention to provide a developer which is used in a hybrid developing device suitable for providing a high image quality and an image forming method which uses the developer.

### Means for Solving the Problem

The present invention is directed to a developer which is used in a hybrid developing device which includes a developer transporting body for charging the developer containing carrier and toner while holding magnetism and a developer carrying body for transferring the toner thereto from the transporting body and for forming a thin toner layer on a surface thereof, and which is for applying a developing bias to the developer carrying body so as to carry out latent image developing of a latent image carrying body, wherein a specific resistance of the carrier is set to a value which falls within a range of 1×10⁹ to 1×10¹² Ω·cm, the saturation magnetization of the carrier is set to a value which falls within a range of 36 to 60 emu/g, and a specific resistance of the toner is set to a value which falls within a range of 1×10¹³ to 1×10¹⁶ Ω·cm. Due to such a constitution, it is possible to overcome the above-mentioned drawbacks.

That is, by setting the specific resistances of the carrier and the toner to the values which fall within predetermined ranges, an electrostatic adhesive force between the carrier and the toner is optimized and hence, the toner transfer between the developer transporting body and the developer carrying body may be carried out smoothly. As a result, the thickness of a thin toner layer formed on the developer carrying body may be maintained at a uniform thickness thus enabling the acquisition of a clear image of high quality with the least generation of a ghost phenomenon.

On the other hand, by setting the saturation magnetization of the carrier to the value which falls within the predetermined range, it may be possible to control the intensity of a magnetic brush on the developer carrying body to a proper value and hence, the uniform thin toner layer having no brush mark may be formed and, at the same time, the generation of a jumping of carrier in which the carrier is transferred to the image carrying body may be prevented.

Accordingly, by suppressing the generation of a ghost phenomenon attributed to the irregularities of the thickness of the thin toner layer, the jumping of carrier phenomenon which is liable to be easily occur when the electrostatic adhesive force or the intensity of the magnetic brush is not optimized, or leaking of an electric current which is liable to easily occur when the specific resistance of the carrier is not optimized, it may be possible to obtain the clear image of high quality.

Further, in constituting the developer of the present invention, it is preferable that an average particle size of the carrier is set to a value which falls within a range of 20 to 45 μm.

Due to such a constitution, with respect to the relationship between the specific resistance and the saturation magnetization, it may be possible to provide the carrier particle size suitable for the hybrid developing device. Hence, it may be possible to obtain the clear image of high quality by preventing the drawbacks such as the jumping of carrier or the like.

Further, in constituting the developer of the present invention, it is preferable that the toner contains a binder resin and carbon black and, at the same time, an addition quantity of the carbon black is set to a value which falls within a range of 0.01 to 30 parts by weight with respect to 100 parts by weight of the binder resin.

Due to such a constitution, it may be possible to provide the black toner which exhibits the excellent coloring property and the excellent fixing property.

Further, in constituting the developer of the present invention, it is preferable that silica fine particles are exteriorly added to the toner and, at the same time, a covering ratio of the silica fine particles is set to a value which falls within a range of 50 to 90% with respect to the toner.

Due to such a constitution, it may be possible to optimize a mixing ratio between the toner and the silica fine particles thus effectively preventing the coagulation of toner particles whereby it may be possible to provide the toner which exhibits the excellent dispersing property.

Further, in constituting the developer of the present invention, it is preferable that a content of the toner is set to a value which falls within a range of 0.1 to 20 weight % when a total quantity of the developer is set to 100 weight %.

Due to such a constitution, the mixing ratio between the toner and the carrier is optimized thus enabling the acquisition of the stable charging property. As a result, it may be possible to effectively prevent the generation of the jumping of carrier and the ghost phenomenon.

Further, in constituting the developer of the present invention, it is preferable that assuming an average degree of circularity of toner as α and the saturation magnetization of the toner as β (emu/g), a following relationship formula (1) is established between α and β.
30α−26.8≦|β|≦30α−22.2 (1)

Due to such a constitution, the toner becomes magnetic toner which contains magnetic powder and hence, between the toner and the carrier, not only the electrostatic adhesive force but also the magnetic adhesive force are generated. Accordingly, by generating both of these adhesive forces in a well-balanced manner, it may be possible to maintain the adhesive force between the toner and the carrier at an optimal state whereby it may be possible to acquire the excellent transfer efficiency.

Further, in constituting the developer of the present invention, it is preferable that in the hybrid developing device, a thickness restricting blade for restricting a height of a magnetic brush is arranged around the developer transporting body.

Due to such a constitution, a height of the bristles of the magnetic brush formed on the developer transporting body is controlled to a value which falls within a predetermined range and hence, it may be possible to easily carry out the thickness adjustment of the thin toner layer on the developer carrying body.

Further, in constituting the developer of the present invention, it is preferable that, in the hybrid developing device, a closest distance between the developer transporting body and the developer carrying body is set to a value which falls within a range of 0.3 to 1.5 mm, and a closest distance between the developer carrying body and the latent image carrying body is set to a value which falls within a range of 150 to 400 μm.

Due to such a constitution, it may be possible to prevent the generation of drawbacks attributed to the matching between the developer and the developing device such as the toner jump or the jumping of carrier and, at the same time, it may be possible to obtain the clear image of high quality.

Further, in constituting the developer of the present invention, it is preferable that, in the hybrid developing device, a reverse bias applying means for returning the toner which is transported to the developer carrying body to the developer transporting body side is provided.

Due to such a constitution, it may be possible to remove the thin toner layer having the non-uniform thickness which is formed by the repeated use of the toner thin layer. Hence, it may be possible to supply the toner thin layer which always maintains the excellent uniformity in the film thickness.

Further, another aspect of the present invention is directed to an image forming method which is characterized by using any one of the above-mentioned developers. That is, when the image is formed by using such developers, it may be possible to provide the clear and high-quality image with the least generation of the jumping of carrier, the ghost phenomenon and the leaking of the electric current.

### BRIEF EXPLANATION OF THE DRAWINGS

FIG. 1 is a view which serves to explain an image forming apparatus;

FIG. 2 is a view which serves to explain a developing device in the image forming apparatus;

FIG. 3 is a view which serves to explain a step in which a developer is transferred;

FIG. 4 is a view which serves to explain a ghost phenomenon;

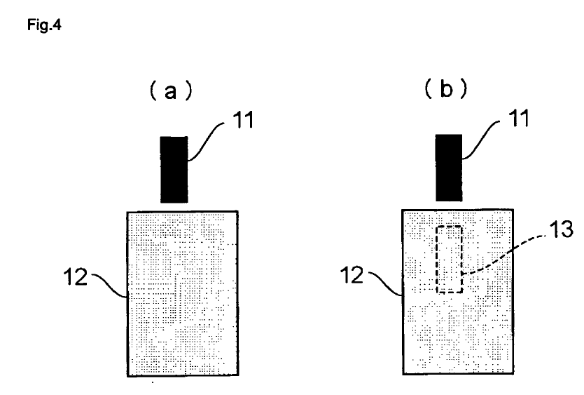

FIG. 5 is a view which serves to explain the relationship between the average degree of circularity of the toner and the saturation magnetization (1);

FIG. 6 is a view which serves to explain the relationship between the average degree of circularity of the toner and the saturation magnetization (2); and

FIG. 7 is a view which serves to explain the relationship between the average degree of circularity of the toner and the saturation magnetization (3).

### BEST MODE FOR CARRYING OUT THE INVENTION

### First Embodiment

The first embodiment is directed to a developer which is used in a hybrid developing device which includes a developer transporting body for charging the developer containing carrier and toner while holding magnetism and a developer carrying body for transferring the toner thereto from the transporting body and for forming a thin toner layer on a surface thereof, and which is for applying a developing bias to the developer carrying body so as to form a latent image of a latent image carrying body, wherein a specific resistance of the carrier is set to a value which falls within a range of 1×10⁹ to 1×10¹² Ω·cm, the saturation magnetization of the carrier is set to a value which falls within a range of 36 to 60 emu/g, and a specific resistance of the toner is set to a value which falls within a range of 1×10¹³ to 1×10¹⁶ Ω·cm.

Hereinafter, the developer of the first embodiment will be explained in conjunction with the respective constitutional features of the developer.

1. Toner

(1) Basic Constitution

With respect to the basic constitution of a developer which is used in the first embodiment, it is preferable that the developer is mainly constituted of a binder resin, a wax group, a coloring agent, a charge control agent and an exteriorly adding agent.

(2) Binder Resin

Although a kind of the binder resin used in the toner of the present invention is not particularly limited, as the binder resin, it is preferable to use a thermoplastic resin such as, for example, a styrene resin, an acrylic resin, styrene-acrylic copolymer, a polyethylene resin, a polypropylene resin, a vinyl chloride resin, a polyester resin, a polyamide resin, a polyurethane resin, a polyvinyl alcohol resin, a vinyl ether resin, a N-vinyl resin, a styrene-butadiene resin etc.

Further, it is preferable that an addition quantity of the binder resin is set to a value which falls with in a range of 45 to 65 weight % with respect to a total quantity of the toner.

The reason is that when the addition quantity becomes excessively low, the toner particles are liable to be melted to each other and hence, there may be a case that the preservation stability is lowered, while, when the addition quantity of the binder resin becomes excessively high, there may be a case that the fixing property of the toner is lowered.

Accordingly, with respect to the total quantity of the toner particles, it is preferable to set the addition quantity of the binder resin to a value which falls within a range of 50 to 60 weight %, and it is more preferable that the addition quantity of the binder resin is set to a value which falls within a range of 52 to 58 weight %.

(3) Wax

Further, although the wax used in the toner of the present invention is not particularly limited, one kind of or the combination of two or more kinds of the wax selected from a group consisting of a polyethylene wax, a polypropylene wax, a fluororesin wax, a fischer-tropsch wax, a paraffin wax, an ester wax, a montan wax, a rice wax and the like may be named for example.

Further, an addition quantity of the wax is not also particularly limited. For example, it is preferable to set the addition quantity of the wax to a value which falls within a range of 0.1 to 20 weight % when the toner total quantity is set to 100 weight %.

The reason is that when the addition quantity of the wax is less than 0.1 weight %, there arises the tendency that an offset to a reading head, image smearing and the like may not be efficiently prevented, while when the addition quantity of the wax exceeds 5 weight %, the toner particles are melted together thus giving rise to a tendency in which the preservation stability is lowered.

Accordingly, it is preferable to set the addition quantity of the wax to a value which falls within a range of 1 to 10 weight %, and it is more preferable to set the addition quantity of the wax to a value which falls within a range of 3 to 7 weight %.

(4) Coloring Agent

Further, although a coloring agent used in the toner of the present invention is not particularly limited, as the coloring agent, it is preferable to use a carbon black, a acetylene black, a lamp black, a aniline black, an azo pigment, an yellow iron oxide, the loess, a nitro type dye, an oil color, a benzidine type pigment, a quinacridone type pigment, a copper phthalocyanine type pigment or the like.

Further, an addition quantity of the coloring agent is not particularly limited. For example, it is preferable to set the addition quantity of the coloring agent to a value which falls within a range of 0.01 to 30 weight % when the toner total quantity is set to 100 weight %.

The reason is that when the addition quantity of the coloring agent is less than 0.01 weight %, the image density becomes low thus giving rise to a tendency that the acquisition of a clear image becomes difficult, while when the addition quantity of the coloring agent exceeds 30 weight %, there arises a tendency that the fixing property is lowered.

Accordingly, it is preferable to set the addition quantity of the coloring agent to a value which falls within a range of 0.1 to 20 weight % and it is more preferable to set the addition quantity of the coloring agent to a value which falls within a range of 1 to 10 weight %.

(5) Charge Controlling Agent

It is preferable to add a charge control agent to the toner used in the present invention. The reason is that the addition of the charge control agent may remarkably enhance a charge level or the charge rise characteristic (an index to indicate whether toner is changed to a fixed charge level in a short time) thus providing the excellent durability and stability.

Kinds of charge control agent are not particularly limited. It is preferable to use the charge control agent which exhibits the positive charging property such as, for example, nigrosine, quaternary ammonium salt chemical compound, a resin type charge control agent which bonds an amine chemical compound to a resin.

Further, when the total quantity of the toner is set to 100 weight %, it is preferable to set the addition quantity of the charge control agent to a value which falls within a range of 1.0 to 10 weight %. The reason is that when the addition quantity of the charge control agent is less than 1.0 weight %, it is difficult to apply the stable charge to the toner and hence, there may be cases in which the image density is lowered, so-called fogging occurs, or the durability is lowered, while when the addition quantity of the charge control agent exceeds 10 weight %, there may be a case that defects such as the poor environment resistance property, particularly the insufficient charge and defective image under high temperature and high moisture condition, the contamination of a photoreceptor or the like are liable to be generated.

Accordingly, it is preferable to set the addition quantity of the charge control agent to a value which falls within a range of 2 to 8 weight %, and it is more preferable to set the addition quantity of the charge control agent to a value which falls within a range of 3 to 7 weight %.

(6) Additive Agent

Here, as an additive agent with respect to the toner used in the present invention, it is preferable to exteriorly add aggregated silica particles, for example to the toner.

Further, with respect to the particle distribution of the aggregated silica particles used in this embodiment, it is preferable that a ratio of the aggregated silica particles having the particle size of 5 μm or less is set to a value equal to or less than 15% with respect to the total quantity of the aggregated silica particles, and a ratio of the aggregated silica particles having the particle size of 50 μm or more is set to a value equal to or less than 3% with respect to the total quantity of the aggregated silica particles.

The reason is that when the ratio of the aggregated silica particles having the particle size of 5 μm or less exceeds 15%, the aggregated silica particles are liable to be easily adhered to the photoreceptor so that the aggregated silica particles are re-aggregated and, at the same time, the aggregated silica particles are gathered around the aggregated silica particles having relatively large particle sizes so that the layer irregularities are liable to be easily generated, while when the ratio of the aggregated silica particles having the particle size of 50 μm or more exceeds 3%, the aggregated silica particles having the relatively small particle sizes are gathered around these aggregated silica particles thus forming large aggregated silica particles whereby the layer irregularities are also liable to be easily generated.

Accordingly, with respect to the range of particle distribution of the aggregated silica particles, it is preferable to set the ratio of the aggregated silica particles having the particle size of 5 μm or less to 0.1 to 10% and the ratio of the aggregated silica particles having the particle size of 50 μm or more to 0.1 to 2%. Further, it is more preferable to set the ratio of the aggregated silica particles having the particle size of 5 μm or less to 1 to 10% and the ratio of the aggregated silica particles having the particle size of 50 μm or more to 1 to 2%.

Here, the particle distribution of aggregated silica particles can be measured by using a laser diffraction grating particle size measuring device LA-500 made by Horiba LTD.

Further, it is preferable to set the specific resistance of the aggregated silica particles to a value which falls within a range of 1×10¹⁰ to 1×10¹⁶ Ω·cm.

The reason is that by restricting the specific resistance of the aggregated silica particles to such a predetermined value, it may be possible to enhance the transporting-ability of the toner.

Here, the specific resistance of the aggregated silica particles can be measured by using a four-terminal method. That is, in a state that the aggregated silica particles are sandwiched between electrodes, a load of approximately 200 Kgf/cm² is applied so as to compress a thickness of the aggregated silica particles to approximately 1 to 3 mm and, thereafter, an electric current which flows when a voltage of 1000V is applied is measured thus calculating the specific resistance of the aggregated silica particles.

Further, in the use of the silica fine particles as the additive agent, it is preferable to use the silica fine particles such that a coverage factor of the silica fine particles with respect to the toner is set to a value which falls within a range of 50 to 90%.

The reason is that by setting the coverage factor to the value which falls within such a range, the fluidity of the toner is enhanced and hence, it may be possible to obtain the developer which exhibits the excellent dispersibility. However, when the coverage factor exceeds 90%, the quantity of silica fine particles becomes excessively large compared to the quantity of the toner particles and hence, the extra silica fine particles which are not adhered to surfaces of the toner particles are re-aggregated thus giving rise to a case that the fluidity of the developer is lowered.

Further, to the contrary, when the coverage factor becomes less than 50%, there may be a case that the acquisition of the sufficient dispersibility becomes difficult.

Accordingly, with respect to the range of the coverage factor, it is preferable to set the coverage factor to a value which falls within a range of 60 to 90%, and it is more preferable to set the coverage factor to a value which falls within a range of 75 to 85%.

Here, the coverage factor of the silica fine particles with respect to the toner can be obtained by photographing the toner particles to which silica fine particles are exteriorly added using an electron microscope or the like, and by respectively calculating a surface area (S1) of the toner and an accumulated area (S2) which is covered with the silica fine particles based on the obtained microscope photographs, and by calculating (S2/S1)×100(%).

Further, as the additive agent used in the present invention, it is preferable to add titanium oxide.

Further, it is preferable to set an average particle size of titanium oxide to a value which falls within a range of 0.01 to 0.50 μm.

The reason is that when the average particle size of titanium oxide becomes less than 0.01 μm, it is difficult to exhibits the uniform polishing effect to titanium oxide and hence, the charge-up occurs or an image flow is generated under high temperature and high moisture condition thus leading to the occurrence of image defects. On the other hand, when the average particle size of titanium oxide exceeds 0.50 μm, the irregularities of the charge quantity in the toner are increased thus giving rise to a case in which image density is lowered or the durability is lowered.

Accordingly, it is preferable to set the average particle size of titanium oxide to a value which falls within a range of 0.02 to 0.4 μm, and it is more preferable to set the average particle size of titanium oxide to a value which falls within a range of 0.05 to 0.3 μm.

Here, the average particle size of titanium oxide is measured as follows. That is, by suitably using the magnification ranging from 30,000 times to 100,000 times, and by using an electronic microscope JSM-880 (JEOL DATMU Ltd.), longitudinal diameters and lateral diameters of 50 particles are respectively measured and averages of these diameters are obtained thus calculating the average particle size of titanium oxide.

Further, it is preferable to apply surface treatment to surfaces of titanium oxide particles with a titanate compound (containing titan-based coupling agent).

The reason is that by applying such surface treatment, it may be possible to easily introduce a hydrophobic group to the surfaces of titanium oxide particles. Accordingly, with the use of titanium oxide particles to which the surface treatment is applied, it may be possible to prevent the lowering of the charging properties of the toner under high temperature and high moisture condition particularly.

Here, as a preferred titanate compound, one kind or the combination of two or more kinds of the titanate compound from a group consisting of isopropyl triisostearoyl titanium, a vinyl trimethoxy titanium, a naphthyl trimethoxy titanium, a phenyl trimethoxy titanium, a methyl trimethoxy titanium, an ethyl trimethoxy titanium, a propyl trimethoxy titanium, an isobutyl trimethoxy titanium, an octadecyl trimethoxy titanium and the like is named.

Further, it is preferable to set the volume specific resistance of titanium oxide to a value 1×10⁴ Ω·cm or more.

The reason is that when the volume specific resistance assumes a value less than 1×10⁴ Ω·cm, there may be a case that the charging property under high temperature and high moisture condition is remarkably lowered, while when the volume specific resistance of titanium oxide becomes excessively large, there may be a case that the charge-up is liable to be generated easily or the charging property under low temperature and low moisture condition is remarkably lowered.

Accordingly, it is preferable to set the volume specific resistance of titanium oxide to a value which falls within a range of 1×10⁴ to 1×10⁷ Ω·cm, and it is more preferable to set the volume specific resistance of titanium oxide to a value which falls within a range of 5×10⁵ to 5×10⁶ Ω·cm.

Here, the volume specific resistance value of titanium oxide can be measured by using ULTRA HIGH RESISTANCE METER (ADVANTEST Corporation, R8340A) under the measuring condition that a load of 1 kg is applied to titanium oxide in a state that titanium oxide is sandwiched between the electrodes and subsequently a voltage of 10 V is applied to titanium oxide.

Further, it is preferable to set an addition quantity of titanium oxide to a value which falls within a range of 0.5 to 2.5 parts by weight with respect to 100 parts by weight of toner particles.

The reason is that when the addition quantity becomes less than 0.5 parts by weight, there may be a case that it is difficult to acquire the effective abrasion effect and the charging property under high temperature and high moisture condition is remarkably lowered. On the other hand, when the addition quantity exceeds 2.5 parts by weight, there may be a case that the charge-up is liable to be easily generated and the charging property under low temperature and low moisture condition is remarkably increased locally.

Accordingly, it is more preferable to set the addition quantity of titanium oxide to a value which falls within a range of 1 to 2 parts by weight with respect to 100 parts by weight of toner particles. It is still more preferable to set the addition quantity of titanium oxide to a value which falls within a range of 1.2 to 1.6 parts by weight with respect to 100 parts by weight of toner particles.

(7) Specific Resistance

Further, the developer which is used in the present invention is characterized in that the specific resistance of the toner falls within a range of 1×10¹³ to 1×10¹⁶ Ω·cm.

The reason is that when the specific resistance of the toner becomes less than 1×10¹³ Ω·cm, leaking of an electric current occurs between the developer carrying body and the latent image carrying body (photoreceptor) and hence, a charge potential of a surface of the photoreceptor is changed thus giving rise to a case that a latent image is not accurately formed. In such a case, white spots are partially formed on the image and, particularly, the lowering of the image quality may become apparent when a black matted image is printed.

To the contrary, when the specific resistance value of the toner becomes more than 1×10¹⁶ Ω·cm, an electrostatic adhesive force between the carrier and the toner may become excessively strong on a magnetic sleeve and hence, the transfer of the toner between the developer carrying body and the developer carrying body may become to be difficult. In such a case, the variation or irregularities of the film thickness are generated on the thin layer which is formed on the developer carrying body thus eventually leading to a case that a ghost phenomenon occurs.

Accordingly, with respect to the value of the specific resistance of the toner, it is preferable to set the specific resistance to a value which falls within a range of 5×10¹³ to 5×10¹⁵ Ω·cm, and it is more preferable to set the specific resistance to a value which falls within a range of 1×10¹⁴ to 5×10¹⁵ Ω·cm. Here, the specific resistance of the toner can be measured by a method which is later described in the example 1.

(8) Volume Average Particle Size

Further, although the volume average particle size of the toner is not particularly limited, usually, it is preferable to set the volume average particle size to a value which falls within a range of 3 to 20 μm.

The reason is that when the volume average particle size of the toner becomes less than 3 μm, there arises a tendency that the stable manufacture of the toner becomes difficult, while when the volume average particle size of the toner exceeds 20 μm, there arises a tendency that the acquisition of the high-quality image becomes difficult. Accordingly, it is preferable to set the volume average particle size of the toner to a value which falls within a range of 4 to 15 μm, and it is more preferable to set the volume average particle size of the toner to a value which falls within a range of 6 to 10 μm.

Here, the particle size of the toner is a value obtained by measuring the particle size of the toner in a state that the toner is not covered with the additive agent and it is possible to measure the particle size of the toner by using a laser diffraction grating particle size measuring device LA-500 made by Horiba Seisakusho company LTD.

(9) Addition Quantity

Further, it is preferable to set the content of the toner to a value which falls within a range of 0.1 to 20 weight % when the developer total quantity is set to 100 weight %.

The reason is that when the content of the toner becomes the value which is less than 0.1 weight %, there arises a tendency that the image density becomes low and it is difficult to obtain the clear image, while when the content of the toner exceeds 20 weight %, there arises a tendency that the carrier content becomes relatively low and the charging property of the toner is lowered.

Accordingly, with respect to the content of the toner, it is preferable to set the content of the toner to a value which falls within a range of 1 to 15 weight %, and it is more preferable to set the content of the toner to a value which falls within a range of 3 to 10 weight %.

(10) Relationship Between Average Degree of Circularity and the Saturation Magnetization

Further, in constituting the toner used in the present invention, assuming an average degree of circularity of the toner particles as α and the saturation magnetization of the toner as β (emu/g), it is preferable that the relationship between α and β satisfies a following relationship formula (1).
30α−26.8≦|β|≦30α−22.2 (1)

The reason is that when the toner of the present invention satisfies such a relationship formula, with the use of the developer in which the average degree of circularity of the toner particles and the saturation magnetization satisfy the predetermined relationship, it may be possible to maintain the adhesive force between the toner particles and the carrier particles to an optimum state. Hence, it may be possible to reduce the scattering of the toner while maintaining the excellent transfer efficiency.

Here, the relationship formula (1) will be explained in detail.

First of all, by adjusting the average degree of circularity (α) and the saturation magnetization (β) of the toner particles such that a left-hand side 30α−26.8≦|β| of the relationship formula (1) is satisfied, even when the average degree of circularity of the toner particles is set to a high value, it may be possible to allow the toner particles to possess the sufficient saturation magnetization. Accordingly, it may be possible to maintain the adhesive force between the toner particles and the carrier particles at a proper strength. Hence, it may be possible to reduce the scattering of the toner while maintaining the excellent transfer efficiency.

Further, by adjusting the average degree of circularity (α) and the saturation magnetization (β) of the toner particles such that a right-hand side |β|≦30α−22.2 of the relationship formula (1) is satisfied, it may be possible to prevent the adhesion strength between the toner particles and the carrier particles from becoming excessively strong whereby it may be possible to prevent the lowering of the density of the formed image while decreasing the scattering of the toner.

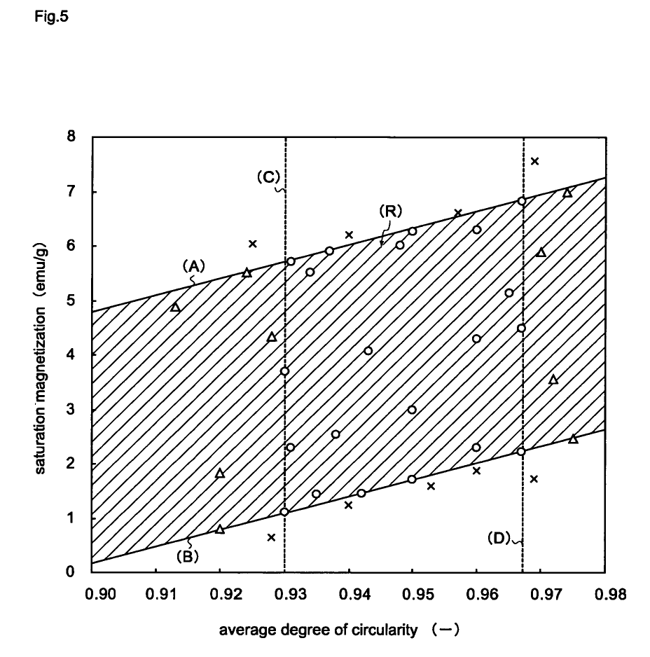

Further, a graph shown in FIG. 5 for explaining the relationship formula (1) is a characteristic graph in which the saturation magnetization (β) of the toner particles is taken on an axis of ordinates and the average degree of circularity (α) of the toner particles is taken on an axis of abscissas.

In such a characteristic graph, a straight line (A) is relevant to the right-hand side of the relationship formula (1). That is, the straight line (A) is expressed by β=30α−22.2.

Further, a straight line (B) is relevant to the left-hand side of the relationship formula (1). That is, the straight line (B) is expressed by β=30α−26.8.

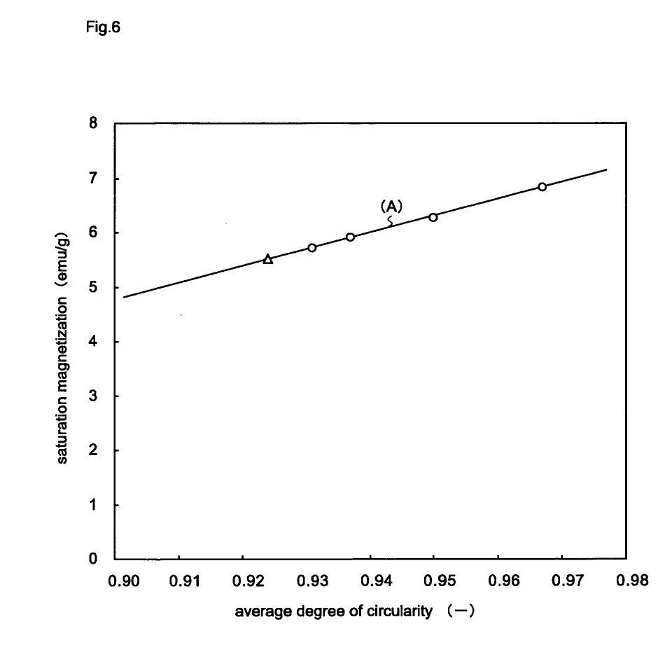

Here, the above-mentioned straight line (A) is, as shown in FIG. 6, prepared by using a least square approximation method with respect to five kinds of toner particles positioned at an uppermost portion in a region (R) shown in FIG. 5.

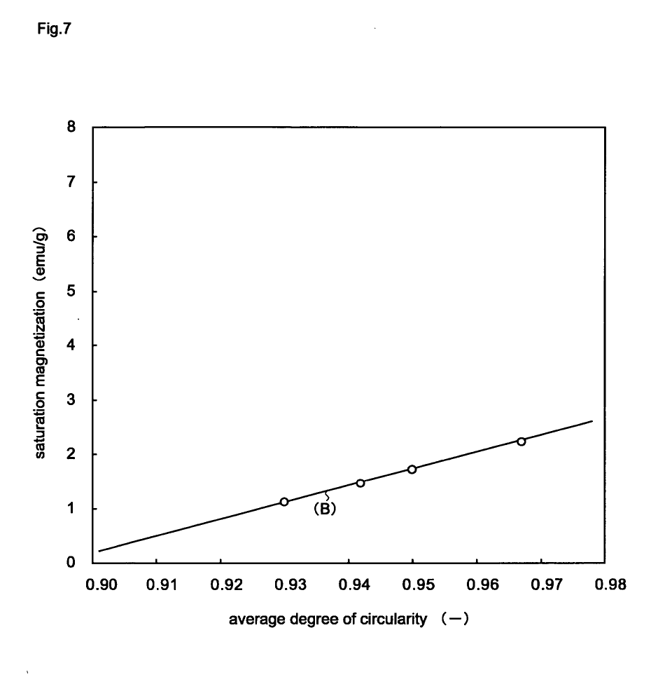

Further, the above-mentioned straight line (B) is, as shown in FIG. 7, is prepared by using a least square approximation method with respect to four kinds of toner particles positioned at a lowermost portion in a region (R) shown in FIG. 5.

Then, the region (R) which is surrounded by these straight lines (A) to (B) constitutes a region which satisfies the range of the above-mentioned relationship formula (1).

That is, the region (R) which is expressed by the relationship formula (1) is determined from a range defined by values which toner particles having the favorable evaluations when the image formation is carried out in the hybrid developing method by using the developers which take various values with respect to the average degree of circularity (α) and the saturation magnetization (β) of the toner particles satisfy.

To be more specific, the relationship formula (1) is obtained as follows. That is, the scattering of toner, the transfer efficiency, the cleaning property and the image density are evaluated by using methods described in examples described later. Then, the relationship formula (1) is introduced from conditions which the average degree of circularity (α) and the saturation magnetization (β) of the toner particles in the developers which exhibit the favorable general evaluation satisfy.

Further, it is preferable to set the saturation magnetization (β) of the toner particles to a value which falls within a range of 1.0 to 7.5 (emu/g) while taking the relationship formula (1) into consideration.

The reason is that even when the condition according to the relationship formula (1) is satisfied, when the saturation magnetization (β) of the toner particles assumes a value less than 1.0 (emu/g), the adhesive force between the toner particles and the carrier particles becomes excessively weak thus giving rise to a tendency that the scattering of toner occurs, while even when the condition according to the relationship formula (1) is satisfied, when the saturation magnetization (β) of the toner particles exceeds 7.5 (emu/g), the adhesive force between the toner particles and the carrier particles becomes excessively strong thus giving rise to a tendency that the density of the formed image becomes low.

Accordingly, it is preferable to set the saturation magnetization (β) of the toner particles to a value which falls within a range of 1.5 to 7.0 (emu/g), and it is more preferable to set the saturation magnetization (β) of the toner particles to a value which falls within a range of 2.0 to 6.5 (emu/g).

Here, the measuring method of the saturation magnetization of the toner particles will be explained in the examples described later.

Further, it is preferable to set the average degree of circularity (α) of the toner particles to a value a value which falls within a range of 0.930 to 0.967.

The reason is that even when the condition according to the relationship formula (1) is satisfied, when the average degree of circularity (≢) assumes a value less than 0.930, the peeling of the toner particles with respect to the surface of the latent image carrying body is lowered thus giving rise to a case that the transfer efficiency is extremely lowered, while even when the condition according to the relationship formula (1) is satisfied, when the average degree of circularity (α) exceeds 0.967, in a cleaning step, the number of toner particles which slip through a cleaning blade is increased thus giving rise to a case that the cleaning property is lowered.

To illustrate the above-mentioned relationship, a hatched region (R) in FIG. 5 satisfies the relationship. That is, a region surrounded by the straight lines (C) to (D) corresponds to a range in which the condition of the relationship is satisfied.

Here, the straight line (C) is expressed by α=0.930.

Further, the straight line (D) is expressed by α=0.967.

(11) Producing Method

Further, the producing method of the toner is preferably carried out as follows. First of all, the above-mentioned binder resin, wax, coloring agent and other additive agents when necessary are premixed by using a known method and, thereafter, melting and kneading process is carried out so as to prepare a toner-use resin composition. Then, the obtained toner-use resin composition is pulverized by using a known method and, thereafter, the classifying process is carried out to obtain the toner particles.

Here, it is preferable to carry out the premixing process by using, for example, a Henschel mixer, a ball mill, a super mixer, a dry blender or the like.

Further, it is preferable to carry out the melting and kneading process by using, for example, a twin-screw extruder, one-screw extruder or the like. Further, it is preferable to carry out the pulverizing process by using, for example, an airflow type pulverizer. Still further, it is preferable to carry out the classifying process by using, for example, an air classifying machine or the like.

The toner which is obtained in this manner is mixed with the above-mentioned additive agents in a known method thus forming the toner which contains the additive agents.

As a method for mixing, the additive agents are mixed with the toner by using a Henschel mixer or the like.

2. Carrier

(1) Basic Constitution

With respect to the basic constitution of the carrier used in the present invention, it is preferable that the carrier is constituted of a carrier core and a covering material which covers such a carrier core.

(2) Carrier Core

As the carrier core which constitutes a portion of the carrier, it is preferable to use magnetic powder. As kinds of preferable magnetic powders, metal or alloy which exhibits ferromagnetism such as ferrite, magnetite, iron, cobalt, nickel or the like, a compound which contains these ferromagnetic elements, and alloy or the like which does not contain ferromagnetic elements but exhibits the ferromagnetism when proper heat process is applied thereto can be named.

Further, as such a carrier core, it is also preferable to use the carrier core which is manufactured by dispersing the above-mentioned magnetic powder in a binder resin such as a polyvinyl alcohol resin, polyvinyl acetal resin, and the mixture is granulated. That is, the magnetic powder, the binder resin and the additive agents or the like when necessary are mixed to each other in a dispersed state and, thereafter, the mixture is granulated and are dried to produce core green particles. Thereafter, the obtained carrier core green particles are baked and crushed by using the known methods thus obtaining the carrier cores.

Here, it is preferable to carry out the granulating process by using a spray drier or the like, for example. Further, the baking process may be carried out by using an electric furnace, an infrared lamp or the like, for example. Further, it is preferable to carry out the crushing process by using a hammer mill or the like, for example. Further after the crushing process, it is desirable to carry out the classifying process by using an air classifier or the like.

(3) Covering Material

Further, as a covering material of the carrier, it is preferable to use a polyester type resin, a polyethylene type resin, a fluorine type resin, an acrylic type resin, a silicone type resin, an epoxy type resin, a phenolic type resin or the like.

Further, it is preferable to set a covering quantity of the covering material to a value which falls within a range of 0.1 to 20 parts by weight with respect to 100 parts by weight of the carrier core 100. The reason is that when the addition quantity of the covering material becomes the value which is less than 0.1 parts by weight, the covering material may not sufficiently cover the carrier core thus giving rise to a tendency that the durability and the charging property are lowered. On the other hand, when the addition quantity of the covering material assumes a value larger than 20 parts by weight, there arises a tendency that the fluidity is lowered or spents are liable to easily occur.

Further, it is preferable that the whole surface or a portion of the periphery of the carrier is covered with the covering material. The reason is that when the whole surface of the periphery of the carrier is covered with the covering material, the fluidity of the toner is enhanced, while when the periphery of the carrier is partially covered with the covering material, it may be possible to maintain the durability and the charging property over a long period.

Further, when the periphery of the carrier is partially covered with the covering material, it is preferable to set a covering ratio to a value which falls within a range of 0.1 to 90%. Further, such a covering ratio can be measured by using a scanning-type electron microscope (made by JEOL LTD., JSM-6380LV) and an image analyzer (made by NIPPON AVIONICS CO LTD., EXCEL) in combination. That is, a surface of the carrier particle covered with resin is magnified using the scanning type electron microscope at a magnification of 500 times under conditions of an acceleration voltage of 50 KV and the degree of vacuum of 50 Pa, a reflective image photographing and a usual SEM photographing of the magnified surfaces are carried out thus obtaining two microscopic photographs of a bright viewing field image and a dark viewing field image. Two photographs which are obtained in this manner are taken into the image analyzer, and image processing is carried out in a state that these photographs are overlapped to each other thus calculating the covering ratio.

Here, it is preferable to use an additive agent in the covering material of the carrier. As such an additive agent, for example, inorganic fine particles made of titanium oxide, zinc oxide, silica or the like, a hardening agent, a coloring agent or the like can be named.

Further, it is preferable to set an addition quantity of such an additive agent to a value which falls within a range of 0.1 to 20 parts by weight with respect to 100 parts by weight of the covering material.

(4) Specific Resistance

Further, the developer which is used in the present invention is characterized in that the specific resistance of the carrier is set to a value which falls within a range of 1×10⁹ to 1×10¹² Ω·cm.

The reason is that when the specific resistance of the carrier assumes a value less than 1×10⁹ Ω·cm, there arises a tendency that leaking of an electric current occurs between the magnetic sleeve and the developing sleeve, while when the specific resistance of the carrier becomes larger than 1×10¹² Ω·cm, there arises a tendency that an electrostatic adhesive force between the carrier on the magnetic sleeve and the toner is increased. Accordingly, the toner is not be sufficiently transferred and hence, a ghost phenomenon occurs and, at the same time, the carrier receives the charges of polarity opposite to the polarity of the toner after the toner is removed thus giving rise to a tendency that the jumping of carrier occurs.

Accordingly, with respect to the value of the specific resistance of the carrier, it is preferable to set the specific resistance to a value which falls within a range of 5×10⁹ to 5×10¹¹ Ω·cm, and it is more preferable to set the specific resistance to a value which falls within a range of 1×10¹⁰ to 1×10¹¹ Ω·cm.

Here, the specific resistance of the carrier can be measured by using the method described in the example 1 described later.

(5) Saturation Magnetization

Further, the developer which is used in the present invention is characterized in that the saturation magnetization of the carrier is set to a value which falls within a range of 36 to 60 emu/g.

The reason is that when the saturation magnetization of the carrier assumes a value less than 36 emu/g, the strength of bristles of the carrier may become weak. Hence, there arises a tendency that a ghost phenomenon and a jumping of carrier are generated, while when the saturation magnetization of the carrier becomes larger than 60 emu/g, the strength of the bristles of the carrier may become excessively large and hence there arises a possibility that brush marks are formed on an image since the carrier brushes the developing sleeve. Here, the saturation magnetization of the carrier can be measured by using a method described in example 1 which is described later.

(6) Average Particle Size

Further, it is preferable to set the average particle size of the carrier to a value which falls within a range of 20 to 45 μm.

The reason is that by setting the average particle size of the carrier to the value which falls within such a range, it may be possible to restrict the electric property and the magnetic property of the carrier within respective proper ranges. As the result, a thin toner layer is stably formed and hence, it may be possible to prevent the occurrence of the jumping of carrier while preventing the occurrence of the ghost phenomenon.

However, when the average particle size of the carrier assumes a value less than 20 μm, particle sizes of the carrier and the toner come close to each other and hence there may be a case that the jumping of carrier occurs. Further, a magnetization quantity of the carrier is lowered and hence, there may be a case in which the magnetic brush may not be formed stably. In such a case, the irregularities are generated with respect to the thickness of the toner thin layer and hence, there may be a case that the ghost phenomenon occurs eventually.

To the contrary, when the average particle size of the carrier assumes a value which exceeds 45 μm, although the jumping of carrier is hardly generated, a magnetization quantity of the carrier as a whole is excessively increased thus giving rise to a case in which the strength of the magnetic brush becomes excessively high. In such a case, brush marks may be generated on the thin toner layer thus lowering the image property.

Accordingly, with respect to the value of the average particle size of the carrier, it is preferable to set the average particle size to a value which falls within a range of 25 to 40 μm, and it is more preferable to set the average particle size to a value which falls within a range of 30 to 35 μm.

(7) Producing Method

Further, although the producing method of the carrier is not particularly limited, for example, it is preferable to manufacture the carrier such that the covering material and the additive when necessary are applied to the carrier core by coating and, thereafter, the brushing and pulverizing process and the classifying process are carried out to manufacture the carrier.

For example, it is preferable to carry out the coating process by using a spraying method, an immersing method or the like. To be more specific, it is preferable to carry out the coating process by using a fluidized layer granulating device or the like.

Further, it is preferable to carry out the crushing and pulverizing process by using a hammer mill or the like, for example. Further, it is preferable to carry out the classifying process by using an air classifier or the like after the crushing and pulverizing process.

### Second Embodiment

The second embodiment is directed to an image forming method which uses a developer adopted by a hybrid developing device which includes a developer transporting body for charging the developer containing carrier and toner while holding magnetism, a developer carrying body for transferring the toner thereto from the transporting body and for forming a thin toner layer on a surface thereof, and a developing device for applying a developing bias to the developer carrying body so as to develop a latent image on a latent image carrying body, wherein a specific resistance of the carrier is set to a value which falls within a range of 1×10⁹ to 1×10¹² Ω·cm, the saturation magnetization of the carrier is set to a value which falls within a range of 36 to 60 emu/g, and a specific resistance of the toner is set to a value which falls within a range of 1×10¹³ to 1×10¹⁶ Ω·cm.

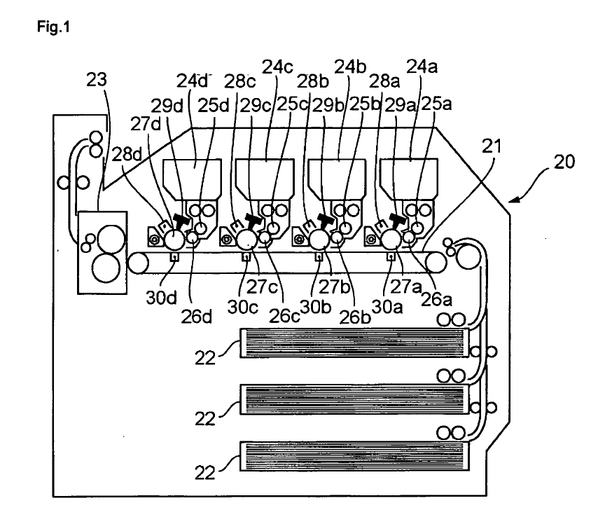

Hereinafter, in conjunction with FIG. 1 to FIG. 3, the second embodiment will be explained in focusing on the constitution of an image forming apparatus which uses the developer adopted by the hybrid developing device and the image forming method, while omitting the contents of the second embodiment which has been explained already in conjunction with the first embodiment.

(1) Basic Constitution

FIG. 1 is a view showing a color image forming device as an example of the image forming apparatus used in the present invention. The color image forming device 20 includes an endless belt (a transporting belt) 21, wherein the endless belt 21 is configured to transport a recording paper fed from a paper feeding cassette 22 to a fixing device 23. Further, above the endless belt 21, a black developing device 24a, a yellow developing device 24b, a cyan developing device 24c and a magenta developing device 24d which constitute hybrid developing devices are respectively arranged along the transporting direction of the recording paper. Further, these hybrid developing devices 24a to 24d respectively include developer transporting bodies (magnetic rollers) 25a to 25d and developer carrying bodies (developing rollers) 26a to 26d. Thin toner layers are formed on the developer carrying bodies 26a to 26d by a hybrid developing method.

Further, photoreceptor drums 27a to 27d which constitute image carrying bodies are arranged in a state that the photoreceptor drums 27a to 27d face the developer carrying bodies 26a to 26d in an opposed manner. Chargers 28a to 28d and exposure devices 29a to 29d are respectively arranged around these photoreceptor drums 27a to 27d. Further, after the photoreceptor drums 27a to 27d are charged by the chargers 28a to 28d, the exposure is carried out on the photoreceptor drums 27a to 27d by the exposure devices 29a to 29d in response to the image data. In this manner, electrostatic latent images are formed on the photoreceptor drums 27a to 27d. Next, the electrostatic latent images on the photoreceptor drums 27a to 27d are developed by the developer carrying bodies 26a to 26d and hence, toner images of respective colors are formed.

Further, to the recording paper which is transported by the endless belt 21, the toner images of respective colors are sequentially transferred by the transfer devices 30a to 30d and hence, a color toner image is formed. Then, the recording paper is transported to the fixing device 23 where the color toner image is fixed and the recording paper is discharge through a paper discharge path.

(2) Developing Device

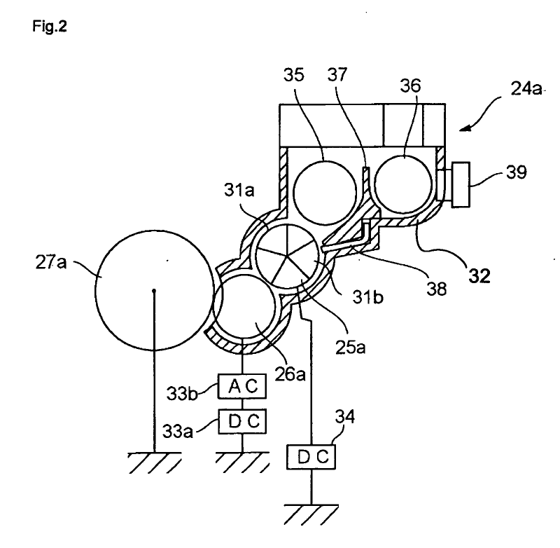

Next, the developing device will be explained in more detail by taking the hybrid developing device 24a as an example in conjunction with FIG. 2.

The hybrid developing device 24a includes the developer transporting body (magnetic roller) 25a and the developer carrying body (developing roller) 26a, wherein the developer transporting body 25a includes a cylindrical rotary sleeve 31a which is made of a non-magnetic metal material and a fixed magnetic body 31b which is arranged in the inside of the rotary sleeve 31a, and a plurality of magnetic poles are formed in the fixed magnetic body 31b. Further, these developer transporting body 25a and the developer carrying body 26a are arranged in the inside of a developing container 32. Further, to the developer carrying body 26a, a DC bias Vdc1 is applied from a direct current (DC) bias power source 33a and, at the same time, an AC bias Vac is applied from an alternating current (AC) bias power source 33b. Still further, to the developer transporting body 25a, a DC bias Vdc2 is applied from direct current (DC) bias power source 34. Here, these bias power sources 33a, 34 are controlled by a control device not shown in the drawing.

Further, in the developing container 32, a paddle mixer 35 and an agitating mixer 36 are provided, wherein a partition plate 37 is disposed between the paddle mixer 35 and the agitating mixer 36. Then, a 2-component developer in the developing container 32 is charged while being agitated and transported by the agitating mixer 36. Then, the developer is supplied to the developer transporting body 25a while being agitated and charged by the paddle mixer 35. Further, a bristle cutting blade (a thickness restricting blade) 38 is arranged to face the developer transporting body 25a in an opposed manner and a height of a magnetic brush formed on the developer transporting body 25a is restricted by the thickness restricting blade 38. Here, a length of the partition plate 37 in the longitudinal direction of the partition plate 37 (an axial direction of the developer carrying body 26a) is smaller than a width of the developing container 32 thus allowing the developer to freely pass at both end sides of the partition plate 37.

(3) Transfer of Developer

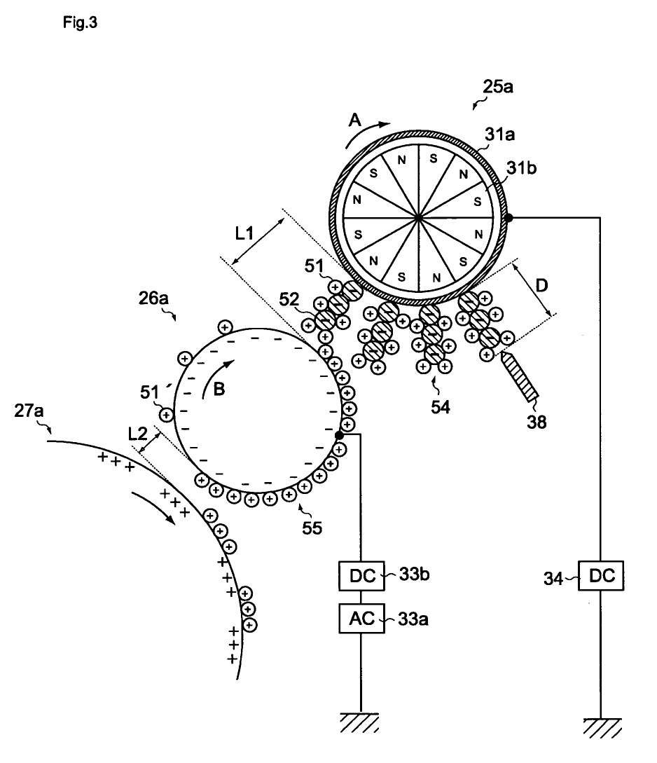

Next, a transfer step of the developer in the hybrid developing device will be explained sequentially in conjunction with FIG. 3.

FIG. 3 is a view showing portions which form constitutional features of the hybrid developing device in the hybrid developing device 24a in FIG. 2 and are picked up and the developer 50 which is constituted of the toner 51 and the carrier 52 are written in addition to such constitutional features.

In FIG. 3, first of all, the developer 50 which is agitated and charged by friction is supplied to the developer transporting body 25a positioned on an upstream side. In the charged developer 50, the toner and the carrier attract each other due to an electrostatic adhesive force, the carrier 52 is magnetized by the magnetic body 31b, and the magnetic brush 54 which is formed of the toner 51 and the carrier 52 is formed.

The magnetic brush 54 has, as mentioned above, due to the value of the saturation magnetization of the carrier, the height thereof and the strength of bristles thereof restricted to values which fall within predetermined ranges.

Next, along with the rotation of the rotary sleeve 31a, the magnetic brush 54 is rotated in the direction indicated by an arrow A in the drawing. Here, due to the thickness restricting blade 38 which is arranged at a position close to the rotary sleeve 31a with a gap width D therebetween, a distal end portion of the magnetic brush 54 is scraped off and hence the height of the magnetic brush 54 is restricted.

Here, it is preferable to set the gap width D between the rotary sleeve 31a and the thickness restricting blade 38 to a value which falls within a range of 0.4 to 1.0 mm.

The reason is that with such a gap width, it may be possible to restrict the height of the magnetic brush 54 while preventing the thickness restricting blade 38 from coming into contact with the rotary sleeve 31a whereby a quantity of developer on the developer transporting body may be maintained at a proper quantity.

Next, the magnetic brush 54 whose height is restricted in this manner is partially brought into contact with the developer carrying body 26a at a position where the developer transporting body 25a and the developer carrying body 26a are arranged closest to each other (the gap width L1).

Here, by applying the voltage with the polarity opposite to the charging polarity of the toner to the developer carrying body 26a, out of the magnetic brush 54, only the toner 51 is transferred to the developer carrying body 26a.

Further, a quantity of toner to be transferred may be controlled by adjusting an absolute value of the potential difference between the DC bias (Vdc2) and the DC bias (Vdc1) ((Vdc2)−(Vdc1)) (hereinafter expressed as the delta value).

Here, it is preferable to set the gap width L1 at the closest position to a value which falls within a range of 0.3 to 1.5 mm.

The reason is that with such a gap width, a distal end of the magnetic brush whose height is restricted is allowed to be slightly in contact with the developer carrying body and hence, it may be possible to effectively form the thin toner layer on the developer carrying body.

Further, with respect to the values of the applied voltages, it is preferable that the Vdc1 is set to a value which falls within a range of 10 to 100V, the Vdc2 is set to a value which falls within a range of 50 to 200V, and the delta value (|Vdc1−Vdc2|) is set to a value which falls within a range of 100 to 200V.

The reason is that by setting the respective applied voltages in this manner, it may be possible to control the transfer quantity of the toner from the developer transporting body to the developer carrying body within a proper range and, at the same time, it may be possible to prevent the carrier from being transferred to the developer carrying body.

Next, the toner 51 which is transferred in this manner forms the thin toner layer 55 having a predetermined thickness on the developer carrying body 26a. Although the thickness of the thin toner layer 55 may be suitably changed corresponding to the desired image property, it is preferable to set the thickness of the thin toner layer 55 to a value which falls within a range of 10 to 50 μm, for example.

The reason is that so long as the thickness of the thin toner layer 55 assumes the value which falls within such a range, the irregularities of the thickness may become small and hence, it may be possible to obtain an image with the small possibility of the occurrence of a ghost phenomenon.

However, when the layer thickness becomes excessively small, it may be difficult to carry out the film thickness control and, depending on a use environment, the ghost phenomenon may occur. To the contrary, when the layer thickness becomes excessively large, the layer thickness exceeds a range which enables the electric control and, in the same manner, the irregularities of the film thickness are generated leading to the occurrence of the ghost phenomenon. Accordingly, it is preferable to set the layer thickness to a value which falls within a range of 20 to 40 μm, and it is preferable to set the layer thickness to a value which falls within a range of 25 to 35 μm.

Next, the thin toner layer 55 is, at a position where the developer carrying body 26a and the photoreceptor 27a are arranged closest to each other (a gap width L2), selectively transferred to a portion on the surface of the photoreceptor where a latent image is formed. As a result, the latent image depicted on the surface of the photoreceptor is developed and visualized by the toner 51, and in the succeeding transfer step, the visualized image is transferred to the paper and is formed as an image.

Here, it is preferable to set the gap width L2 at the closest position to a value which falls within a range of 150 to 400 μm.

The reason is that with such a gap width L2, there is no possibility that the photoreceptor and the thin toner layer or the developer carrying body are directly brought into contact with each other and hence, it may be possible to adopt a so-called jumping developing method which develops the image by jumping the toner by an electric attraction force whereby it may be possible to provide a developing device which exhibits the excellent durability.

Further, also in such a developing step, there may exist the toner which remains on the developer carrying body as the thin toner layer without being transferred to the photoreceptor. Such residual toner is indicated as a residual toner 51′ in FIG. 3. The residual toner 51′ is moved along with the movement of the developer carrying body 26a which is rotated in the direction B and, again, is brought into contact with the magnetic brush 54. Here, a portion of the residual toner 51′ is mixed with the magnetic brush 54, while another portion of the residual toner 51′ remains on the developer carrying body 26a as it is. In this manner, the residual toner 51′ is brought into contact with the magnetic brush 54 again, the thin toner layer 55 having a fixed film thickness is continuously held on the developer carrying body.

However, when the image formation is carried out continuously, there may be a case that the uniformity of the thickness of the thin toner layer 55 may be lowered. In such a case, it is preferable to provide a reverse bias applying means which applies a reverse bias at the timing that the image is not formed, that is, at the timing which does not contribute to the image formation such as the timing between the feeding of one printing paper and the feeding of another printing paper, for example.

By applying the reverse bias in this manner, the toner 51 which constitutes the thin toner layer 55 formed on the developer carrying body may be temporarily transferred to the developer transporting body. As the result, the thin toner layer 55 on the developer carrying body is temporarily peeled off and the new thin toner layer is formed again whereby it may be possible to continuously supply the thin toner layer which exhibits the excellent uniformity in the film thickness for a long period.

Further, as the reverse bias applying means, a DC power source may be provided additionally besides the DC power source 33a and the DC power source 34. Alternatively, without providing the additional power source, it may be also possible to obtain the substantially equal effect by inverting the potential difference between the DC power source 33a and the DC power source 34.

Further, with respect to materials and sizes of the respective members which constitute the above-mentioned developing device, for example, the rotary sleeve 31a has a diameter of 20 mm or less and is made of stainless steel, and the developer carrying body 26a has a diameter of 20 mm or less and is made of aluminum. Further, stainless steel may be used as a material of the thickness restricting blade 38.

### EXAMPLES

1. Producing Method of Various Toners

(1) Producing Method of Toner A

90 parts by weight of polyester (number-average molecular weight: 4300, weight-average molecular weight: 9800, Tg=58° C.), 3 parts by weight of Fischer Tropsch wax (made by NIPPON SEIRO CO. LTD) and 9.5 parts by weight of carbon black Pr-90 (made by SHOWA CABOT KK) are mixed under conditions of 3000 rpm, 55° C. or less, for 10 minutes by using a Henschel mixer. Thereafter, the compound is fused and kneaded by using a twin screw extruder thus adjusting a toner resin composite. The obtained toner resin composite is pulverized by using an airflow type pulverizer and, further, the classifying process is carried out by using an air classifying machine thus obtaining a core member having a volume average particle size of 9 μm. Next, silica fine particles having an average particle size of 20 nm, 60 degree of hydrophobicity, specific resistance value of 10¹² Ω·cm is added to the above-mentioned core member so that a covering ratio of the silica fine particles is 80% with respect to the core member and the compound is mixed for 10 minutes by using a Henschel mixer 3000 rpm so as to manufacture the toner A. Here, specific resistance value of the toner A is 4.6×10¹⁴ Ω·cm.

Further, the covering ratio of the silica fine particles with respect to the toner particles is measured by a scanning type electron microscope (JEOL LTD Co., Ltd., JSM-6380LV). That is, to the surface of the carrier particles which is covered with a resin coat, reflective image photographing and a normal SEM photographing are carried out by enlarging by 500 times under conditions of an accelerating voltage pf 50 KV and degree of vacuum of 50 Pa (reflection) and the obtained two photographs are taken into an image analyzer (made by NIPPON AVIONICS CO LTD., EXCEL) and an image processing is carried out to these two photographs in an overlapping manner thus calculating the covering ratio.

Here, the degree of hydrophobicity is measured by using methanol titration test. That is, methanol is dropped from a burette until whole amount of 0.2 g of silica fine particles which are added to 50 ml of water is wet while stirring the solution and, at the end point, the degree of hydrophobicity is indicated by the methanol (%) contained in a mixture of methanol and water.

(2) Producing Method of Toner B

Except for that addition quantity of carbon black is set to 11 parts by weight, a toner B is manufactured in the same manner as the toner A. Specific resistance value of the toner B is 2.8×10¹³ Ω·cm.

(3) Producing Method of Toner C

Except for that addition quantity of carbon black is set to 8.5 parts by weight, a toner C is manufactured in the same manner as the toner A. Specific resistance value of the toner C is 7.8×10¹⁵ Ω·cm.

(4) Producing Method of Toner D

Except for that addition quantity of carbon black is set to 11.5 parts by weight, a toner D is manufactured in the same manner as the toner A and specific resistance value of the toner D is 5.4×10¹² Ω·cm.

(5) Producing Method of Toner E

Except for that addition quantity of carbon black is set to 8 parts by weight, a toner E is manufactured in the same manner as the toner A and the specific resistance value of the toner E is 1.7×10¹⁶ Ω·cm.

2. Measurement of Specific Resistance of Toner

Specific resistance value of a toner is measured in a following manner. That is, the toner is made into pellets having a size of φ20 mm and a thickness of 1 mm by applying a load of 200 Kgf/cm² and, thereafter, the pellets are sandwiched between electrodes, a voltage is applied to the pellets, and an electric current which flows the pellets is measured to obtain the specific resistance of the toner. Here, as a measurement condition, the load is 180 g and the measuring electric intensity is 2×10⁴ V/m.

3. Producing Method and Evaluations for Various Carriers

(1) Producing method of carrier A 20 parts by weight of CuO, 15 parts by weight of ZnO and 65 parts by weight of Fe₂O₃ are filled in a dry ball mill and grinded and mixed for two hours under a rotational condition of 120 rpm. Next, the compound is baked under conditions of 800° C. and two hours by using a rotary kiln. The obtained magnetic particles are pulverized for two hours under a rotational condition of 120 rpm by using a ball mill and, thereafter, 10 parts by weight of poly vinyl alcohol (PVA-235: KURARAY CO., LTD.) is added and the compound is granulated by using a spray drier. Thereafter, the compound is baked under conditions of 1200° C., 20 hours in an electric furnace and, further, the compound is granulated by using a hammer mill and hence, a carrier core is obtained.

The carrier core manufactured in this manner is coated with 20 parts by weight of silicone resin (SR2115, made by DOW CORNING TORAY SILICONE CO., LTD.) and 2 parts by weight of titanium oxide (EC-100, made by TITAN KOGYO KK) under conditions of 180° C., 3 hours by using a fluidized bed granulator. Thereafter, the compound is crashed and pulverized by using a Hybridizer and, further, sieving is carried out by using a dispersion separator and hence, carrier particles A having a specific resistance value of 2.5×10¹⁰ Ω·cm and a saturation magnetization of 47 emu/g are obtained.

Here, with respect to the specific resistance of the carrier, the carrier particles are filled in a cell and electrodes are arranged in a state that the electrodes are brought into contact with the filled carrier and an electric current which flows at the time of applying a voltage between the electrodes is measured and the specific resistance value of the carrier is calculated. That is, as a measuring condition of the specific resistance, the contact area between the filled carrier and the electrodes is approximately 2.3 cm², a thickness of 0.5 mm, a load of 180 g and a measuring electric intensity of 2×10⁴ V/m.

Further, the measurement of saturation magnetization of the carrier is carried out under 1K oerstead using a vibration magnetometer VSM-3S-15 (made by TOEI Industry Co. Ltd) and the magnetization quantity thereof is assumed as a saturation magnetization.

(2) Producing Method of Carrier B

By carrying out the producing steps substantially equal to the producing steps of the producing method of carrier A except for the addition of 3 parts by weight of titanium oxide, carrier particles B having a specific resistance value of 3.1×10⁹ Ω·cm and saturation magnetization of 47 emu/g are obtained.

(3) Producing Method of Carrier C

By carrying out the producing steps substantially equal to the producing steps of the producing method of carrier A except for the addition of 1 parts by weight of titanium oxide, carrier particles C having a specific resistance value of 7.1×10¹¹ Ω·cm and saturation magnetization of 47 emu/g are obtained.

(4) Producing Method of Carrier D

By carrying out the producing steps substantially equal to the producing steps of the producing method of carrier A except for the addition of 5 parts by weight of titanium oxide, carrier particles D having a specific resistance value of 6.9×10⁸ Ω·cm and saturation magnetization of 47 emu/g are obtained.

(5) Producing Method of Carrier E

By carrying out the producing steps substantially equal to the producing steps of the producing method of carrier A except for not adding titanium oxide, carrier particles E having a specific resistance value of 2.2×10¹² Ω·cm and saturation magnetization of 47 emu/g are obtained.

(6) Producing Method of Carrier F

By carrying out the producing steps substantially equal to the producing steps of the producing method of carrier A except for preparing a raw material by blending 15 parts by weight of CuO, 10 parts by weight of ZnO and 75 parts by weight of Fe₂O₃ and pulverizing and mixing the raw material for two hours by using a ball mill, carrier particles F having a specific resistance value of 2.5×10¹⁰ Ω·cm and saturation magnetization of 38 emu/g are obtained.

(7) Producing Method of Carrier G

By carrying out the producing steps substantially equal to the producing steps of the producing method of carrier A except for preparing a raw material by blending 20 parts by weight of CuO, 20 parts by weight of ZnO and 60 parts by weight of Fe₂O₃ and pulverizing and mixing the raw material for two hours by using a ball mill, carrier particles G having a specific resistance value of 2.5×10¹⁰ Ω·cm and saturation magnetization of 55 emu/g are obtained.

(8) Producing Method of Carrier H

By carrying out the producing steps substantially equal to the producing steps of the producing method of carrier A except for preparing a raw material by blending 15 parts by weight of CuO, 5 parts by weight of ZnO and 80 parts by weight of Fe₂O₃ and pulverizing and mixing the raw material for two hours by using a ball mill, carrier particles H having a specific resistance value of 2.5×10¹⁰ Ω·cm and saturation magnetization of 30 emu/g are obtained.

(9) Producing Method of Carrier I

By carrying out the producing steps substantially equal to the producing steps of the producing method of carrier A except for preparing a raw material by blending 20 parts by weight of CuO, 30 parts by weight of ZnO and 50 parts by weight of Fe₂O₃ and pulverizing and mixing the raw material for two hours by using a ball mill, carrier particles I having a specific resistance value of 2.5×10¹⁰ Ω·cm and saturation magnetization of 63 emu/g are obtained.

4. Evaluation of Ghost Phenomenon

In performing the evaluation of the ghost phenomenon, the obtained developer is set in a color printer LS-5016 (made by KYOCERA MITA Corporation) and the image is formed with the original density of 100%. Immediately thereafter, a matted image is outputted with the original density of 25%, and the density of a portion which is obtained by rotating the developing sleeve by exactly 1 rotation from the formation of the image with the density of 100% and the density of the 25% matted image are respectively measured by using a reflection density sensor (SpectroEye made by GretagMacbeth AG), and the density difference is obtained. Based on the obtained density difference, the ghost phenomenon is evaluated based on following criteria.

Here, the ghost phenomenon is, as shown in FIG. 5(a), a phenomenon in which when a rectangular black matted solid image 11 is printed and, thereafter, a half-tone image 12 which is wider than the solid image 11 is printed subsequently, an image retention portion (ghost) 13 occurs. That is, the ghost phenomenon is, as shown in FIG. 5(b), a phenomenon in which attributed to a fact that toner consumption regions and toner non-consumption regions are present on the developer carrying body, the image retention portion (ghost) 13 occurs in the half-tone image 12.

Very good: The density difference is below 0.01%.

Good: The density difference is 0.01 to below 0.015%.

Fair: The density difference is 0.016 to below 0.018%.

Bad: The density difference is a value which is 0.019% or more.

5. Evaluation of Leaking Property

The leaking property is evaluated by outputting the matted image with the image density of 100% and by confirming the presence or the non-presence of leaking with naked eyes. That is, when the white portion is present in the matted image with the image density of 100%, the evaluation “bad” is given, while when the white portion is not present in the matted image with the image density of 100%, the evaluation “good” is given.

6. Evaluation of Jumping of Carrier

The jumping of carrier is evaluated by outputting the matted image with the image density of 100% and by confirming the presence or the non-presence of jumping of carrier with naked eyes. That is, when a white portion is present in the matted image with the image density of 100%, the evaluation “bad” is given, while when a white portion is not present in the matted image with the image density of 100%, the evaluation “good” is given.

Here, the evaluation of jumping of carrier is an evaluation method which uses the same technique as the above-mentioned evaluation of leaking property. However, the leaking of an electric current occurs in a local region, while the jumping of carrier occurs over the whole image and hence, it may be possible to distinguish whether the generated white point is attributed to the leaking of an electric current or the jumping of carrier.

### Example 1

A toner A and a carrier A are blended such that the toner density becomes 10% and, then, are agitated and mixed uniformly by using a ball mill to manufacture the developer.

By using such a developer and a color printer LS-5016 (made by KYOCERA MITA Corporation), the image is formed, wherein a surface potential of a photoreceptor is set to 200V, a surface potential of a magnetic sleeve is set to 200V, a surface potential of a developing sleeve is set to 50V, and a frequency and a peak voltage of an AC voltage applied between the photoreceptor and the developing sleeve are set to 2.4 KHz and 1.3 KV respectively. Then, the above-mentioned evaluation of ghost phenomenon, evaluation of leaking property and evaluation of jumping of carrier are carried out and the obtained results are shown in Table 1.

### Examples 2 and 3

In the examples 2 and 3, except for that toners B and C are used, the evaluations of the ghost phenomenon and the like are carried out in the same manner as the example 1 and the obtained results are shown in Table 1.

### Examples 4 to 7

In the examples 4 to 7, except for that carriers B, C, F, G are used, the evaluations of the ghost phenomenon and the like are carried out in the same manner as the example 1 and the obtained results are shown in Table 1.

### Comparison Examples 1 and 2

In the comparison examples 1 and 2, except for that toners D and E are used, the evaluations of the ghost phenomenon and the like are carried out in the same manner as the example 1 and the obtained results are shown in Table 1.

### Comparison Examples 3 to 6

In the comparison examples 3 to 6, except for that carriers D, F, H, 1 are used, the evaluations of the ghost phenomenon and the like are carried out in the same manner as the example 1 and the obtained results are shown in Table 1.

TABLE 1

| | Kind | | Ghost | Leak | Jumping of |
|---|---|---|---|---|---|
| | of | Kind of | developing | generation | carrier |
| | toner | carrier | evaluation | evaluation | evaluation |
| Example 1 | A | A | Very good | Good | Good |
| Example 2 | B | A | Good | Good | Good |
| Example 3 | C | A | Fair | Good | Good |
| Example 4 | A | B | Good | Good | Good |
| Example 5 | A | C | Fair | Good | Good |
| Example 6 | A | F | Good | Good | Good |
| Example 7 | A | G | Good | Good | Good |
| Comparison | D | A | Good | Bad | Good |
| example 1 | | | | | |
| Comparison | E | A | Bad | Good | Good |
| example 2 | | | | | |
| Comparison | A | D | Good | Bad | Bad |
| example 3 | | | | | |
| Comparison | A | E | Bad | Good | Bad |
| example 4 | | | | | |
| Comparison | A | H | Bad | Good | Bad |
| example 5 | | | | | |
| Comparison | A | I | Good | Good | Good |
| example 6 | | | (image | | |
| | | | quality: | | |
| | | | Bad) | | |

As can be understood from the results shown in Table 1, in the examples 1 to 7, the developers in which the carriers have the specific resistance of 1×10⁹ to 1×10¹² Ω·cm, the saturation magnetization of 36 to 60 emu/g, and the toner has the specific resistance of 1×10¹³ to 1×10¹⁶ Ω·cm are used and hence, the generation of the ghost phenomenon is suppressed whereby it may be possible to obtain the favorable image having no leaking and jumping of carrier.

On the other hand, in the comparison example 1, the specific resistance of the toner is small, that is, 5.4×10¹² Ω·cm and hence, the leaking occurs.

Further, in the comparison example 2, the specific resistance of the toner is large, that is, 1.7×10¹⁶ Ω·cm and hence, the electrostatic adhesive force between the carrier and the toner is strong whereby the toner may not be sufficiently supplied to the developing sleeve thus generating the ghost phenomenon.

Further, in the comparison example 3, the specific resistance of the carrier is small, that is, 6.9×10⁸ Ω·cm and hence, the leaking and the jumping of carrier are generated.

Further, in the comparison example 4, the specific resistance of the carrier is large, that is, 2.2×10¹² Ω·cm and hence, the electrostatic adhesive force between the carrier and the toner is strong whereby the toner may not be sufficiently supplied to the developing sleeve thus generating the ghost phenomenon. Further, the jumping of carrier attributed to the reverse charging after removal of the toner occurs.

Further, in the comparison example 5, the saturation magnetization of the carrier is small, that is, 30 emu/g and hence, bristles of the carrier are weak whereby the ghost occurs and, at the same time, the jumping of carrier occurs.

Further, in the comparison example 6, the saturation magnetization of the carrier is large, that is, 63 emu/g and hence, although the ghost phenomenon does not occur, the carrier strongly brushes the developing sleeve and hence, the brush marks appear on the image.

What we claim is:

1. A developer which is used in a hybrid developing device which includes a developer transporting body for charging the developer containing carrier and toner while holding magnetism, a developer carrying body for transferring the toner thereto from the transporting body and for forming a thin toner layer on a surface thereof, and which is for applying a developing bias to the developer carrying body so as to form a latent image of a latent image carrying body, wherein
a specific resistance of the carrier is set to a value which falls within a range of 1×10⁹ to 1×10¹² Ω·cm, the saturation magnetization of the carrier is set to a value which falls within a range of 36 to 60 emu/g, and a specific resistance of the toner is set to a value which falls within a range of 1×10¹³ to 1×10¹⁶ Ω·cm.

2. The developer according to claim 1, wherein an average particle size of the carrier is set to a value which falls within a range of 20 to 45 μm.

3. The developer according to claim 1, wherein the toner contains a binder resin and carbon black and, at the same time, an addition quantity of the carbon black is set to a value which falls within a range of 0.01 to 30 parts by weight with respect to 100 parts by weight of the binder resin.

4. The developer according to claim 1, wherein silica fine particles are exteriorly added to the toner and, at the same time, a covering ratio of the silica fine particles is set to a value which falls within a range of 50 to 90% with respect to the toner.

5. The developer according to claim 1, wherein a content of the toner is set to a value which falls within a range of 0.1 to 20 weight % when a total quantity of the developer is set to 100 weight %.

6. The developer according to claim 1, wherein assuming an average degree of circularity of toner as α and the saturation magnetization of the toner as β (emu/g), a following relationship formula (1) is established between α and β.
30α−26.8≦|β|≦30α−22.2 (1)

7. The developer according to claim 1, wherein in the hybrid developing device, a thickness restricting blade for restricting a height of a magnetic brush is arranged around the developer transporting body.

8. The developer according to claim 1, wherein in the hybrid developing device, a closest distance between the developer transporting body and the developer carrying body is set to a value which falls within a range of 0.3 to 1.5 mm, and a closest distance between the developer carrying body and the latent image carrying body is set to a value which falls within a range of 150 to 400 μm.

9. The developer according to claim 1, wherein in the hybrid developing device, a reverse bias applying means for returning the toner which is transported to the developer carrying body to the developer transporting body is provided.

10. An image forming method which is characterized by using the developer described in claim 1.
